(19) United States
(12) Patent Application Publication
(10) Pub. No.: US 2025/0141517 A1
(43) Pub. Date: May 1, 2025

(54) METHOD AND APPARATUS FOR CONTROLLING WIRELESS CHANNEL STATE PROCESSING IN WIRELESS COMMUNICATION SYSTEM

(71) Applicant: Electronics and Telecommunications Research Institute, Daejeon (KR)

(72) Inventors: Jisoo PARK, Daejeon (KR); Nam Il KIM, Daejeon (KR); Moon-sik LEE, Daejeon (KR); Jun Hwan LEE, Daejeon (KR)

(21) Appl. No.: 18/932,521

(22) Filed: Oct. 30, 2024

(30) Foreign Application Priority Data
Oct. 30, 2023 (KR) 10-2023-0147231
Oct. 28, 2024 (KR) 10-2024-0148496

(51) Int. Cl. H04B 7/06; H04W 24/10; H04W 76/27

(52) U.S. Cl. CPC H04B 7/0626; H04W 24/10; H04W 76/27

(57) ABSTRACT

A method of a user equipment (UE) may comprise: receiving a UE capability enquiry message from a base station; in response to the UE capability enquiry message, transmitting, to the base station, a UE capability message including CSI processing capability information capable of determining a CSI processing timing of the UE; receiving channel state information (CSI) measurement configuration information from the base station; measuring a reference signal (RS) received from the base station based on the CSI measurement configuration information and the CSI processing capability information; and transmitting, to the base station, a first CSI report message based on the measurement of the RS.

### CROSS-REFERENCE TO RELATED APPLICATIONS

This application claims priority to Korean Patent Applications No. 10-2023-0147231, filed on Oct. 30, 2023, and No. 10-2024-0148496, filed on Oct. 28, 2024, with the Korean Intellectual Property Office (KIPO), the entire contents of which are hereby incorporated by reference.

### BACKGROUND

### 1. Technical Field

The present disclosure relates to a technique for controlling processing of a wireless channel state for a wireless channel, and more particularly, to a technique for controlling measurements on a wireless channel and transmission and reception of channel state information.

### 2. Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g. Long Term Evolution (LTE) communication system or LTE-Advanced (LTE-A) communication system), the 5th generation (5G) communication system (e.g. new radio (NR) communication system) that uses a frequency band (e.g. a frequency band of 6 GHz or above) higher than that of the 4G communication system as well as a frequency band of the 4G communication system (e.g. a frequency band of 6 GHz or below) is being considered. The 5G communication system may support enhanced Mobile BroadBand (eMBB), Ultra-Reliable and Low-Latency Communication (URLLC), and massive Machine Type Communication (mMTC).

In particular, wireless communication technologies to support advanced 5G services are evolving to encompass diverse applications and developments, including beamforming utilizing advanced smart antenna technology, massive MIMO (mMIMO) technology, adoption of various wireless frame structures, support for multiple numerology-based system transmission specifications, definition of uplink and downlink physical channels, various types and applications of reference signals, and reporting of wireless channel states.

In the 5G NR communication system, a variety of terminals with different signal processing capabilities characterized by distinct processing timing for handling wireless signals have been proposed. For example, in the 5G NR communication system, terminals with different signal processing capabilities for downlink data channels, uplink data channels, or downlink control channels have been introduced. To address such scenarios of having distinct processing capabilities for the respective channels, the 5G NR standard specifications require methods for adjusting a hybrid automatic repeat request (HARQ) feedback timing based on the terminal's channel-specific processing capabilities or adjusting an uplink data transmission scheduling timing after allocation of a downlink control channel for uplink scheduling.

### SUMMARY

The present disclosure for resolving the above-described problems is directed to providing a method and apparatus for transmitting and/or receiving channel state information based on a wireless channel state processing capability of a terminal.

A method of a user equipment (UE), according to an exemplary embodiment of the present disclosure, may comprise: receiving a UE capability enquiry message from a base station; in response to the UE capability enquiry message, transmitting, to the base station, a UE capability message including CSI processing capability information capable of determining a CSI processing timing of the UE; receiving channel state information (CSI) measurement configuration information from the base station; measuring a reference signal (RS) received from the base station based on the CSI measurement configuration information and the CSI processing capability information; and transmitting, to the base station, a first CSI report message based on the measurement of the RS.

The CSI measurement configuration information may include at least one of information indicating type(s) of RS(s) to be measured by the UE, information on an RS transmission pattern, information on an RS transmission periodicity, information on a location of RS resource(s) in time and frequency domain, or CSI report configuration information, and the CSI report configuration information may include at least one of a position of a slot in which CSI reporting needs to be performed, a periodicity of the slot in which CSI reporting needs to be performed, a periodicity of a transmission time interval (TTI) in which CSI reporting needs to be performed, or a CSI reporting periodicity in time domain.

When measuring RSs received from the base station, the UE may measure only RS(s) required for CSI reporting among RSs received from the base station based on the CSI measurement configuration information and the CSI processing capability information.

The method may further comprise: receiving, from the base station, CSI processing control information including at least one information element among information on a CSI processing timing, information for determining a CSI processing timing, or CSI reporting periodicity;

measuring RS(s) received from the base station based on the CSI processing control information, the CSI measurement configuration information, and the CSI processing capability information; and transmitting a second CSI reporting message based on the measurement of the RS to the base station, based on the CSI measurement configuration information or the CSI processing control information.

The CSI processing control information may be determined based on one or more of a quality of service (QOS) of data traffic provided to the UE, a reliability of a channel between the UE and the base station, a network connection state of the UE, an energy saving mode of the UE, or a type of the UE, and the network connection state of the UE may indicate one of an idle state, a connected state, or an inactive state.

The CSI processing control information may further include information indicating a periodicity of valid RSs among RSs transmitted by the base station.

The terminal may measure only the valid RSs indicated by the CSI processing control information among RSs received from the base station.

A method of a base station, according to an exemplary embodiment of the present disclosure, may comprise: transmitting a user equipment (UE) capability enquiry message to a UE; receiving, from the UE, a UE capability message including CSI processing capability information capable of determining a CSI processing timing of the UE; generating channel state information (CSI) measurement configuration information based on the CSI processing capability information of the UE; transmitting the CSI measurement configuration information to the UE; and receiving a first CSI report message from the UE, wherein the first CSI report message includes information obtained by measuring a reference signal (RS) transmitted by the base station to the UE based on the CSI measurement configuration information and the CSI processing capability information.

The CSI measurement configuration information may include at least one of information indicating type(s) of RS(s) to be measured by the UE, information on an RS transmission pattern, information on an RS transmission periodicity, information on a location of RS resource(s) in time and frequency domain, or CSI report configuration information, and the CSI report configuration information may include at least one of a position of a slot in which CSI reporting needs to be performed, a periodicity of the slot in which CSI reporting needs to be performed, a periodicity of a transmission time interval (TTI) in which CSI reporting needs to be performed, or a CSI reporting periodicity in time domain.

The method may further comprise: generating CSI processing control information based on the CSI processing capability information of the UE and second information; transmitting the CSI processing control information to the UE; and receiving a second CSI report message from the UE based on the CSI measurement configuration information and the CSI processing control information, wherein the CSI processing control information includes one or more information elements among information on a CSI processing timing, information for determining a CSI processing timing, and a CSI reporting periodicity.

The second information may include one or more of a quality of service (QOS) of data traffic provided to the UE, a reliability of a channel between the UE and the base station, a network connection state of the UE, an energy saving mode of the UE, or a type of the UE, and the network connection state of the UE may indicate one of an idle state, a connected state, or an inactive state.

The CSI processing control information may further include information indicating a periodicity of valid RSs among RSs transmitted by the base station.

The method may further comprise: allocating resources to communicate with the UE based on the second CSI report message; and transmitting allocation information on the resources to the UE through downlink control information (DCI).

A user equipment (UE), according to an exemplary embodiment of the present disclosure, may comprise at least one processor, wherein the at least one processor causes the UE to perform: receiving a UE capability enquiry message from a base station; in response to the UE capability enquiry message, transmitting, to the base station, a UE capability message including CSI processing capability information capable of determining a CSI processing timing of the UE; receiving channel state information (CSI) measurement configuration information from the base station; measuring a reference signal (RS) received from the base station based on the CSI measurement configuration information and the CSI processing capability information; and transmitting, to the base station, a first CSI report message based on the measurement of the RS.

The CSI measurement configuration information may include at least one of information indicating type(s) of RS(s) to be measured by the UE, information on an RS transmission pattern, information on an RS transmission periodicity, information on a location of RS resource(s) in time and frequency domain, or CSI report configuration information, and the CSI report configuration information may include at least one of a position of a slot in which CSI reporting needs to be performed, a periodicity of the slot in which CSI reporting needs to be performed, a periodicity of a transmission time interval (TTI) in which CSI reporting needs to be performed, or a CSI reporting periodicity in time domain.

The at least one processor may cause the UE to perform: when measuring RSs received from the base station, measuring only RS(s) required for CSI reporting among RSs received from the base station based on the CSI measurement configuration information and the CSI processing capability information.

The at least one processor may further cause the UE to perform: receiving, from the base station, CSI processing control information including at least one information element among information on a CSI processing timing, information for determining a CSI processing timing, or CSI reporting periodicity; measuring RS(s) received from the base station based on the CSI processing control information, the CSI measurement configuration information, and the CSI processing capability information; and transmitting a second CSI reporting message based on the measurement of the RS to the base station, based on the CSI measurement configuration information or the CSI processing control information.

The CSI processing control information may be determined based on one or more of a quality of service (QOS) of data traffic provided to the UE, a reliability of a channel between the UE and the base station, a network connection state of the UE, an energy saving mode of the UE, or a type of the UE, and the network connection state of the UE may indicate one of an idle state, a connected state, or an inactive state.

The CSI processing control information may further include information indicating a periodicity of valid RSs among RSs transmitted by the base station.

The at least one processor may further cause the UE to perform: measuring only the valid RSs indicated by the CSI processing control information among RSs received from the base station.

According to exemplary embodiments of the present disclosure, the terminal can determine which RS to measure based on the terminal's CSI processing capability rather than measuring all RSs transmitted by the base station. Therefore, the terminal cannot measure RSs that are not used for CSI reporting, providing the advantage of reducing power consumption.

When CSI reporting is performed based on the CSI processing timing, the terminal can transmit more reliable wireless channel information to the base station. Consequently, the base station can allocate more optimal wireless resources to the terminal when scheduling downlink and/or uplink transmissions, allowing the system to achieve enhanced resource allocation efficiency.

### BRIEF DESCRIPTION OF DRAWINGS

FIG. 1 is a conceptual diagram illustrating an exemplary embodiment of a communication system.

FIG. 2 is a block diagram illustrating an exemplary embodiment of a communication node constituting a communication system.

FIG. 3A is a timing diagram illustrating an exemplary embodiment of a method for wireless channel measurement and CSI reporting provided by a wireless communication system.

FIG. 3B is a timing diagram illustrating another exemplary embodiment of a method for wireless channel measurement and CSI reporting provided by a wireless communication system.

FIG. 4 is a sequence chart illustrating a scheduling procedure in which a base station acquires a terminal's CSI processing capability and performs scheduling based on the acquired CSI processing capability, in a wireless communication system.

FIG. 5 is a sequence chart illustrating a procedure for adjusting and scheduling a CSI processing timing based on a service quality of traffic of a terminal in an RRC-connected state in a wireless communication system.

FIG. 6A is a timing diagram illustrating an exemplary embodiment of a method for wireless channel measurement and CSI reporting according to the present disclosure.

FIG. 6B is a timing diagram illustrating another exemplary embodiment of a method for wireless channel measurement and CSI reporting according to the present disclosure.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one A or B” or “at least one of one or more combinations of A and B”. In addition, “one or more of A and B” may refer to “one or more of A or B” or “one or more of one or more combinations of A and B”

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may have the same meaning as a communication network.

Throughout the present disclosure, a network may include, for example, a wireless Internet such as wireless fidelity (WiFi), mobile Internet such as a wireless broadband Internet (WiBro) or a world interoperability for microwave access (WiMax), 2G mobile communication network such as a global system for mobile communication (GSM) or a code division multiple access (CDMA), 3G mobile communication network such as a wideband code division multiple access (WCDMA) or a CDMA2000, 3.5G mobile communication network such as a high speed downlink packet access (HSDPA) or a high speed uplink packet access (HSUPA), 4G mobile communication network such as a long term evolution (LTE) network or an LTE-Advanced network, 5G mobile communication network, beyond 5G (B5G) mobile communication network (e.g. 6G mobile communication network), or the like.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present specification, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

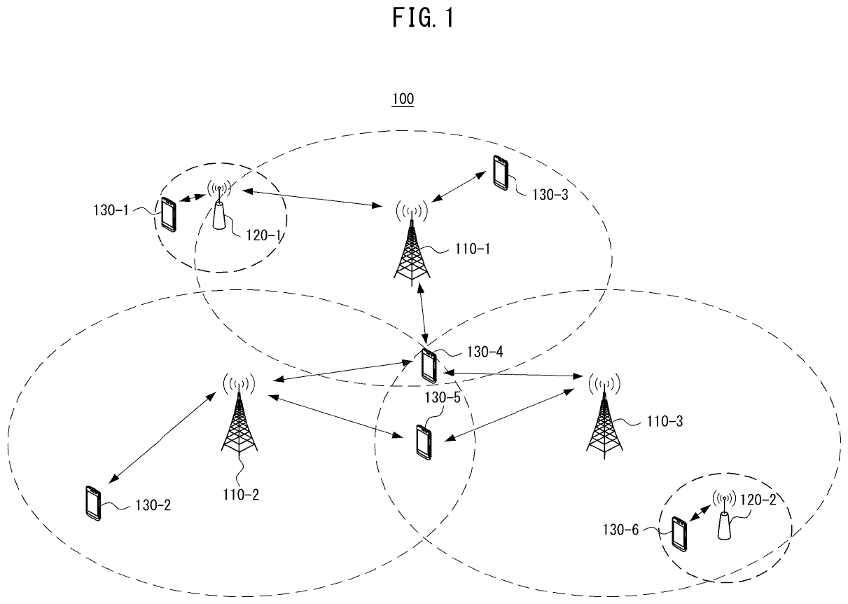

FIG. 1 is a conceptual diagram illustrating an exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes may support 4G communication (e.g. long term evolution (LTE), LTE-advanced (LTE-A)), 5G communication (e.g. new radio (NR)), 6G communication, etc. specified in the 3rd generation partnership project (3GPP) standards. The 4G communication may be performed in frequency bands below 6 GHZ, and the 5G and 6G communication may be performed in frequency bands above 6 GHz as well as frequency bands below 6 GHz.

For example, in order to perform the 4G communication, 5G communication, and 6G communication, the plurality of communication may support a code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform spread OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter bank multi-carrier (FBMC) based communication protocol, universal filtered multi-carrier (UFMC) based communication protocol, space division multiple access (SDMA) based communication protocol, orthogonal time-frequency space (OTFS) based communication protocol, or the like.

Further, the communication system 100 may further include a core network. When the communication 100 supports 4G communication, the core network may include a serving gateway (S-GW), packet data network (PDN) gateway (P-GW), mobility management entity (MME), and the like. When the communication system 100 supports 5G communication or 6G communication, the core network may include a user plane function (UPF), session management function (SMF), access and mobility management function (AMF), and the like.

Meanwhile, each of the plurality of communication nodes 110-1, 110-2, 110-3, 120-1, 120-2, 130-1, 130-2, 130-3, 130-4, 130-5, and 130-6 constituting the communication system 100 may have the following structure.

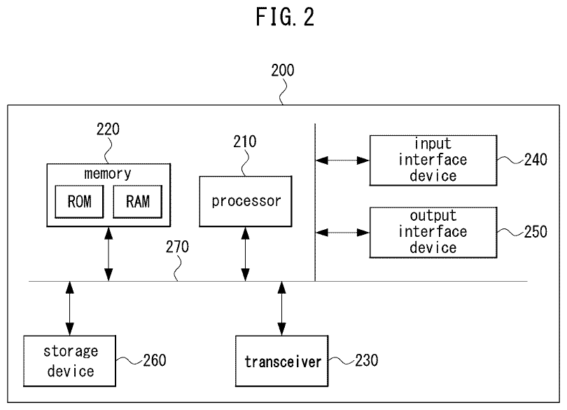

FIG. 2 is a block diagram illustrating an exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B (NB), evolved Node-B (eNB), gNB, base transceiver station (BTS), radio base station, radio transceiver, access point, access node, road side unit (RSU), radio remote head (RRH), transmission point (TP), transmission and reception point (TRP), or the like.

Each of the plurality of terminals 130-1, 130-2, 130-3, 130-4, 130-5, and 130-6 may refer to a user equipment (UE), terminal, access terminal, mobile terminal, station, subscriber station, mobile station, portable subscriber station, node, device, Internet of Thing (IoT) device, mounted module/device/terminal, on-board device/terminal, or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support multi-input multi-output (MIMO) transmission (e.g. a single-user MIMO (SU-MIMO), multi-user MIMO (MU-MIMO), massive MIMO, or the like), coordinated multipoint (CoMP) transmission, carrier aggregation (CA) transmission, transmission in an unlicensed band, device-to-device (D2D) communications (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2, and operations supported by the plurality of base stations 110-1, 110-2, 110-3, 120-1, and 120-2. For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the COMP transmission manner, and the fourth terminal 130-4 may receive the signal from the first base station 110-1, the second base station 110-2, and the third base station 110-3 in the COMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, methods for configuring and managing radio interfaces in a communication system will be described. Even when a method (e.g. transmission or reception of a signal) performed at a first communication node among communication nodes is described, the corresponding second communication node may perform a method (e.g. reception or transmission of the signal) corresponding to the method performed at the first communication node. That is, when an operation of a terminal is described, a corresponding base station may perform an operation corresponding to the operation of the terminal. Conversely, when an operation of a base station is described, a corresponding terminal may perform an operation corresponding to the operation of the base station.

Meanwhile, in a communication system, a base station may perform all functions (e.g. remote radio transmission/reception function, baseband processing function, and the like) of a communication protocol. Alternatively, the remote radio transmission/reception function among all the functions of the communication protocol may be performed by a transmission and reception point (TRP) (e.g. flexible (f)-TRP), and the baseband processing function among all the functions of the communication protocol may be performed by a baseband unit (BBU) block. The TRP may be a remote radio head (RRH), radio unit (RU), transmission point (TP), or the like. The BBU block may include at least one BBU or at least one digital unit (DU). The BBU block may be referred to as a ‘BBU pool’, ‘centralized BBU’, or the like. The TRP may be connected to the BBU block through a wired fronthaul link or a wireless fronthaul link. The communication system composed of backhaul links and fronthaul links may be as follows. When a functional split scheme of the communication protocol is applied, the TRP may selectively perform some functions of the BBU or some functions of medium access control (MAC)/radio link control (RLC) layers.

To provide advanced 5G communication services, the IMT-2020 and 3GPP have set targets such as peak data rates of 20 Gbps and 10 Gbps for downlink and uplink, respectively, a user plane latency of 0.5 ms to 1 ms for URLLC, a user plane latency of 4 ms for eMBB, and a connection density of 106 devices per square kilometer. In addition, to provide advanced 5G communication services, the IMT-2020 and 3GPP have defined requirements for high-capacity and high-speed data transmission based on massive MIMO (mMIMO), ultra-low latency data transmission, and increased terminal density, and are establishing advanced standard technologies to meet these requirements.

According to the 2019 Ericsson mobility report, mobile data traffic is expected to grow 60 times from 2013 until 2024. By 2024, the volume of global mobile data traffic is projected to reach 131 billion gigabytes (B GB) per month. The 2019 Ericsson mobility report also forecasts that multimedia creation and consumption will continue to grow by 74%, with 25% of mobile data traffic being transmitted via 5G networks. This volume of data traffic is 1.3 times greater than the combined traffic of today's 4G, 3G, and 2G networks.

The globally increasing mobile data traffic is driven by the rapid growth in mobilizing media and entertainment contents, the significant increase in rich user-generated contents, congestion in mobile data traffic due to dense user environments, high-speed mobility traffic in high-speed vehicles, traffic from connected cloud computing services, traffic for immersive experience 3D video contents, connected vehicle service traffic, and augmented reality (AR) service traffic. The characteristics of such contents, terminals, and services exhibit similar traffic group properties based on their respective features.

In addition to addressing the increasing volume of mobile data traffic and meeting advanced 5G requirements, improvements are required in the following areas: methods for more efficiently managing the power of terminals, methods for efficiently operating various device types and their transmission services based on device processing capabilities, methods for satisfying the quality of service according to traffic service types of terminals, methods for fair allocation of resources considering the wireless states and transmission loads in highly dense terminal environments, and methods for stable and fast access by configuring systems based on terminal states. Such improvements require the combined application of efficient traffic scheduling.

In a wireless communication system, the procedures for measuring wireless channels, channel estimation, and channel state reporting may refer to processes in which a terminal measures and estimates a wireless channel and report channel state information (CSI) to a base station. The CSI of the wireless channel may be determined by measuring reference signals (RSs) transmitted by the base station and based on these measurements. The RSs may include, for example, Synchronization Signal Blocks (SSBs) or Channel State Information-Reference Signals (CSI-RSs). The base station that receives the CSI reported by the terminal may select optimal wireless resources based on the received CSI. The base station may use the optimal wireless resources to schedule wireless data for the terminal.

Information elements (IEs) included in the CSI may include one or more of a Channel Quality Indicator (CQI), a Precoding Matrix Indicator (PMI), a Rank Indicator (RI), or a Layer Indicator (LI).

The characteristics of wireless channels may vary depending on an environment. For example, in indoor environments, signal reflections are generally more pronounced than signal loss, whereas in outdoor environments, signal loss is generally more significant than signal reflections.

As technology advances, the ability to measure and report wireless channels is also expected to diversify. For example, in the case of a terminal capable of measuring a wide frequency band, a base station may instruct the terminal to perform measurements over the wide band. Based on measurement results reported by the terminal for the wide frequency band, the base station may allocate additional wireless resources to overcome signal reflections. As another example, a terminal with low latency in CSI reporting may have a shorter CSI processing timing. The base station may consider the CSI processing capability of the terminal with short CSI processing timing to select the optimal adaptive channel. The base station may increase wireless transmission efficiency by using a short scheduling timing for the selected optimal adaptive channel.

The diverse capabilities of terminals described above are merely examples, and terminals may be further subdivided into more categories of capabilities in addition to the given examples. In other words, terminals in next-generation mobile communication systems may exhibit different CSI processing capabilities depending on their abilities to measure wireless channels using SSB or CSI-RS, process wireless channel values, and report CSI. Accordingly, next-generation mobile communication systems need to support various reporting procedures tailored to terminal capabilities. Terminals that use significant wireless bandwidth particularly require the capability for wideband channel measurement and reporting. For example, in cases like URLLC where extremely low transmission latency and high reliability are required, the wireless communication system needs to enable the measurement of the latest channel state to enhance reliability and perform wireless resource scheduling using the measured latest CSI. Therefore, communication methods that support transmission and reception of CSI based on terminal capabilities and/or service types are required.

As described above, the base station needs to be able to consider a processing time for channel measurements, CSI processing capability for generation and reporting of measured CSI, etc. for each of various terminals, and needs to schedule wireless resources accordingly.

In next-generation communication technologies discussed in the 5G vision and 6G vision, the existence of various types of terminals and the need for diverse service processing capabilities are emphasized. The capability to measure wireless channels and report channel state information needs to also be defined in accordance with the diverse types of terminals and their service processing capabilities. In other words, system specifications need to distinguish channel state reporting capabilities based on the diverse types of terminals and their service processing capabilities.

Additionally, in CSI reporting through wireless channel measurements, a time required for measurement and reporting, as well as accuracy of the measurement, may vary depending on the terminal's channel state measurement capabilities. Terminals capable of utilizing a significant wireless bandwidth may require wideband wireless channel measurement and CSI processing capabilities. If the base station considers the CSI processing timing (e.g. time required for channel measurement, CSI generation, and CSI reporting) as part of the terminal's capability (i.e. UE capability) based on the characteristics of various terminals, the channel state reporting procedures may precede optimal wireless resource scheduling. Such considerations can improve system performance and enhance wireless usage efficiency.

Accordingly, the present disclosure described below is directed to providing a wireless resource control method that considers wireless channel measurement and CSI processing capability of a terminal.

For example, the conventional CSI reporting method, which performs wireless channel measurement and channel state reporting, has been conducted simply based on the terminal's unknown system capabilities without considering the terminal's diverse wireless channel measurement and CSI processing capabilities.

However, the present disclosure described below will detail methods for measuring wireless channels for each terminal based on the capabilities of each terminal with varying abilities. In addition, the present disclosure will describe methods to enable CSI reporting according to a utilization purpose and/or service purpose of the terminal, based on the various CSI reporting capabilities of the terminal. Furthermore, the present disclosure will describe methods for the base station to schedule terminals based on their respective diverse capabilities and/or service-specific requirements.

First, the conventional method for CSI reporting will be described.

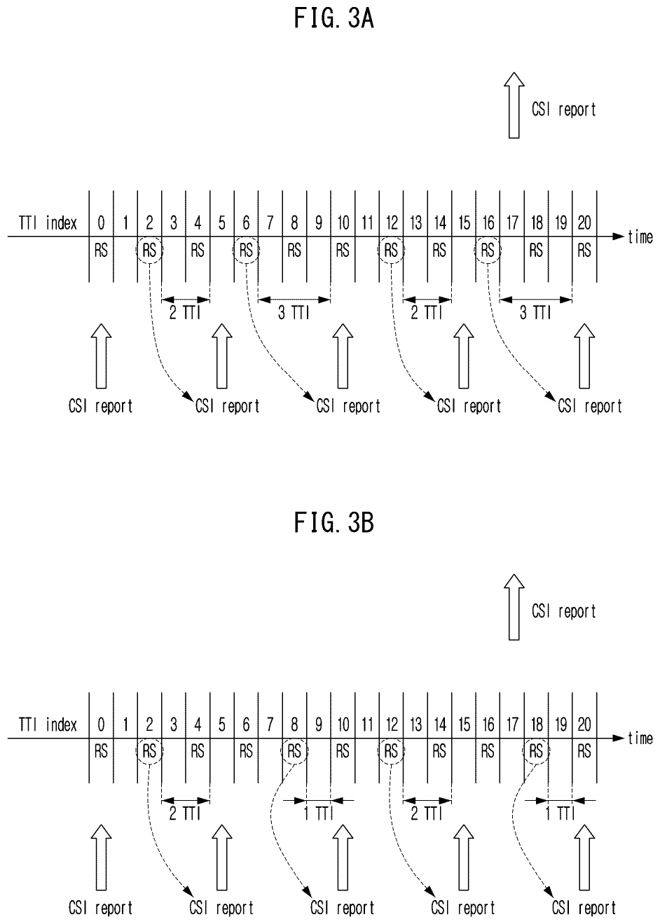

FIG. 3A is a timing diagram illustrating an exemplary embodiment of a method for wireless channel measurement and CSI reporting provided by a wireless communication system.

Referring to FIG. 3A, the horizontal axis may represent time. A transmission time interval (TTI) may be a scheduling unit for a base station to perform data transmission. From a downlink perspective, hierarchically, a medium access control (MAC) layer of the base station may deliver a scheduled transport block (TB) to a physical (PHY) layer at each TTI interval. The PHY layer may transmit the TB received from the MAC layer to a terminal through a radio frequency at each TTI interval. In the LTE system, the length of the TTI may be set to 1 ms. In the LTE system, one frame may be 10 ms, and one subframe may be 1 ms. Therefore, in the LTE system, one TTI may correspond to one subframe. In other words, in the LTE system, one subframe may be a scheduling unit.

On the other hand, in the NR system, a TTI may be determined on a slot basis. Additionally, in the NR system, a duration of each slot may vary depending on a numerology. For example, in the NR system, if a subcarrier spacing (SCS) is 15 kHz, one slot may be 1 ms; if the SCS is 30 kHz, one slot may be 0.5 ms; and if the SCS is 60 kHz, one slot may be 0.25 ms. Since a transmission time of signals in the NR system varies according to the numerology, scheduling may be performed on a slot basis. In other words, in the NR system, a scheduling unit may be a slot.

When considering LTE and NR, a transmission and reception unit in the wireless communication system may be determined as a subframe or a slot. In the following description, for convenience of description, the transmission and reception unit is assumed to be a slot.

In FIG. 3A, a total of 21 TTI indexes from a TTI index #0 to TTI index #20 are illustrated. According to the example in FIG. 3A, the base station may transmit reference signals (RSS) at an interval of two slots. Here, the RS may be an SSB or CSI-RS, as described above.

The base station may transmit a Radio Resource Control (RRC) configuration message or RRC reconfiguration message including a CSI measurement configuration information element (IE) to the terminal. The CSI measurement configuration IE may include information on an RS transmission periodicity and a CSI reporting periodicity. In the following description, the CSI measurement configuration IE may be referred to as ‘CSI measurement configuration’ or ‘CSI measurement configuration information’. In other words, the CSI measurement configuration IE, CSI measurement configuration, and CSI measurement configuration information may be understood to have the same meaning.

The base station may then transmit the RRC configuration message or RRC reconfiguration message including the CSI measurement configuration information to the terminal. The terminal may receive the RRC configuration message or RRC reconfiguration message. The terminal may also determine the RS transmission periodicity and CSI reporting periodicity based on the CSI measurement configuration information included in the RRC configuration message or RRC reconfiguration message.

According to the example in FIG. 3A, the base station may set the RS transmission periodicity to 2 TTIs and the CSI reporting periodicity to 5 TTIs. Therefore, in the example shown in FIG. 3A, the RSs may be transmitted at TTI indexes #0, #2, #4, #6, #8, #10, #12, #14, #16, #18, and #20. Additionally, in the example shown in FIG. 3A, CSI report messages may be transmitted at TTI indexes #0, #5, #10, #15, and #20.

Meanwhile, the terminal may measure a wireless channel and obtain CSI based on the wireless channel measurement. The terminal may receive the RS transmitted by the base station to measure the wireless channel and perform measurement on the received RS. Based on the measured RS, the terminal may generate a CSI report message and report the generated CSI report message to the base station. This series of CSI reporting procedures may be determined based on a CSI processing capability of the terminal. The CSI report message may include one or more of CQI, MIMO PMI, RI, or LI.

FIG. 3A illustrates an example where the terminal's CSI processing capability is 2 TTIs. According to the example in FIG. 3A, the terminal may generate a CSI report message for the RS received at the TTI index #2. Based on a CSI report configuration included in the CSI measurement configuration information, the terminal may transmit the CSI report message to the base station at the TTI index #5.

Similarly, the terminal may generate a CSI report message for the RS received at the TTI index #6 and transmit the CSI report message to the base station at the TTI index #10. Additionally, the terminal may generate a CSI report message for the RS received at the TTI index #12 and transmit the CSI report message to the base station at the TTI index #15. The terminal may also generate a CSI report message for the RS received at the TTI index #16 and transmit the CSI report message to the base station at the TTI index #20.

A reason the terminal transmits the CSI report message for the RS received at the TTI index #6 to the base station at the TTI index #10 as shown in FIG. 3A is that the RS received at the TTI index #8 does not satisfy the CSI processing capability of 2 TTIs. The same reason applies to the case where the terminal performs CSI reporting at the TTI index #20 for the RS received at the TTI index #16.

FIG. 3B is a timing diagram illustrating another exemplary embodiment of a method for wireless channel measurement and CSI reporting provided by a wireless communication system.

In FIG. 3B, an example is illustrated where the terminal's CSI processing capability is 1 TTI. Other conditions may be the same as those in FIG. 3A. For example, in FIG. 3B, as in FIG. 3A, the base station may configure an RS transmission periodicity and a CSI reporting periodicity through CSI measurement configuration information included in an RRC configuration message or RRC reconfiguration message.

According to FIG. 3B, the RS transmission periodicity may be 2 TTIs, and the CSI reporting periodicity may be 5 TTIs. Furthermore, like FIG. 3A, FIG. 3B illustrates a total of 21 TTI indexes from the TTI index #0 to a TTI index #20. Since the RS transmission periodicity is 2 TTIs, the RSs may be transmitted in the same order as in FIG. 3A: TTI indexes #0, #2, #4, . . . , #20.

Since the terminal's CSI processing capability in FIG. 3B is 1 TTI, the terminal may generate a CSI report message for the RS received at the TTI index #2 and transmit the CSI report message to the base station at the TTI index #5. The terminal may generate a CSI report message for the RS received at the TTI index #8 and transmit the CSI report message to the base station at the TTI index #10. The terminal may generate a CSI report message for the RS received at the TTI index #12 and transmit the CSI report message to the base station at the TTI index #15. Additionally, the terminal may generate a CSI report message for the RS received at the TTI index #18 and transmit the CSI report message to the base station at the TTI index #20. The CSI report message may include one or more of CQI, MIMO PMI, RI, or LI.

A reason the terminal transmits the CSI report message for the RS received at the TTI index #2 to the base station at the TTI index #5 as shown in FIG. 3B is that the RS received at the TTI index #4 does not satisfy the CSI processing capability of 1 TTI. Similarly, the terminal may transmit the CSI report message for the RS received at the TTI index #12 at the TTI index #15.

Comparing FIGS. 3A and 3B, it can be seen that the RS used for CSI reporting may differ depending on the terminal's CSI processing capability.

The current standard specifications do not define rules for CSI reporting based on the CSI processing capability of the terminal. As shown in FIGS. 3A and 3B, although only four valid CSI reports are generated for the RSs transmitted every 2 TTIs from the TTI index #0 to TTI index #20, unnecessary resource and energy waste may occur. In other words, in the examples of FIGS. 3A and 3B, CSI report messages are not transmitted to the base station for the remaining seven RS transmissions.

Furthermore, since the base station does not know the terminal's CSI processing capability, the base station is not able to determine which RS transmitted at a specific TTI index corresponds to a CSI report message received from the terminal. This may cause difficulties in efficiently scheduling terminals at the base station.

Comparing FIGS. 3A and 3B, it can also be seen that the CSI reported by the terminal in FIG. 3B, with a CSI processing capability of 1 TTI, may represent more recent CSI than the CSI reported by the terminal in FIG. 3A, with a CSI processing capability of 2 TTIs. Therefore, the CSI reported by the terminal in FIG. 3B may provide more reliable channel information. However, since the base station is unaware of the CSI processing capabilities of the terminals, the base station may need to perform scheduling for the terminals in FIGS. 3A and 3B in the same manner. This results in reduced wireless resource efficiency from the perspective of the wireless communication system.

Additionally, the terminal may need to continuously receive and measure RSs even for RS transmissions for which no CSI report messages are generated. This may cause unnecessary energy consumption due to the reception and measurement of such RSs.

The present disclosure described below provides methods and apparatuses to address these issues.

Even when a method performed by a first communication node (e.g. transmission or reception of a signal) is described in the communication system, a corresponding second communication node may perform a method corresponding to the method performed by the first communication node (e.g. reception or transmission of the signal). In other words, when an operation of a terminal is described, a corresponding base station may perform an operation corresponding to the operation of the terminal. Conversely, when an operation of a base station is described, a corresponding terminal may perform an operation corresponding to the operation of the base station.

Both LTE communication systems and NR 5G communication systems use beamforming technology based on advanced smart antenna technologies to achieve enhanced data transmission. Additionally, the 5G NR communication system supports various wireless frame structures using massive MIMO (mMIMO) technology that employs a large number of antennas. The 5G NR communication n system provides transmission specifications for various numerology configurations to support diverse wireless frame structures and offers shared physical channels (e.g. PUSCH/PDSCH) for uplink and/or downlink data transmission and physical channels (e.g. PUCCH/PDCCH) for uplink and/or downlink control information transmission. The 5G NR communication system may provide RSs that differ from those in the existing LTE communication system. Terminals in the 5G NR communication system may perform CSI reporting, uplink data buffer status reporting (BSR), and the like.

In the 5G NR communication system, downlink RSs may include SSB or CSI-RS. Correspondingly, a CSI report message, which is based on the terminal's measurement of RSs, may include one or more of CQI, MIMO PMI, RI, or LI, as described above.

The base station may determine a channel state of the terminal based on the CSI report message received from the terminal. The base station may also select optimal wireless resources for communication with the terminal based on the CSI report message.

The base station may configure information related to the RS(s) that the terminal needs to measure to receive a CSI report message from the terminal. The information related to the RS(s) may be configured in the CSI measurement configuration (e.g. csi-measConfig) IE included in the RRC configuration message or RRC reconfiguration message. The CSI measurement configuration information may include information indicating type(s) of RS(s) to be measured by the terminal, information indicating an RS transmission pattern, information indicating an RS transmission periodicity, and information on a location of RS resources in the time and/or spatial domain. Accordingly, the base station may transmit the RRC configuration message or RRC reconfiguration message including the CSI measurement configuration information to the terminal.

The terminal may receive the RRC configuration message or RRC reconfiguration message including the CSI measurement configuration information and identify the CSI measurement configuration information from the received RRC configuration message or RRC reconfiguration message. Based on the CSI measurement configuration information, the terminal may receive and measure the RS(s) transmitted by the base station. The terminal may generate a CSI report message based on the measured RS(s) and transmit the generated CSI report message to the base station. The base station may receive the CSI report message transmitted by the terminal based on the CSI measurement configuration information. The base station may then select optimal wireless resources for communication with the terminal based on the received CSI report message and allocate the selected wireless resources to the terminal.

The present disclosure described below provides a wireless resource control method that considers the CSI processing capability of the terminal to efficiently select wireless resources and allocate the selected resources to the terminal.

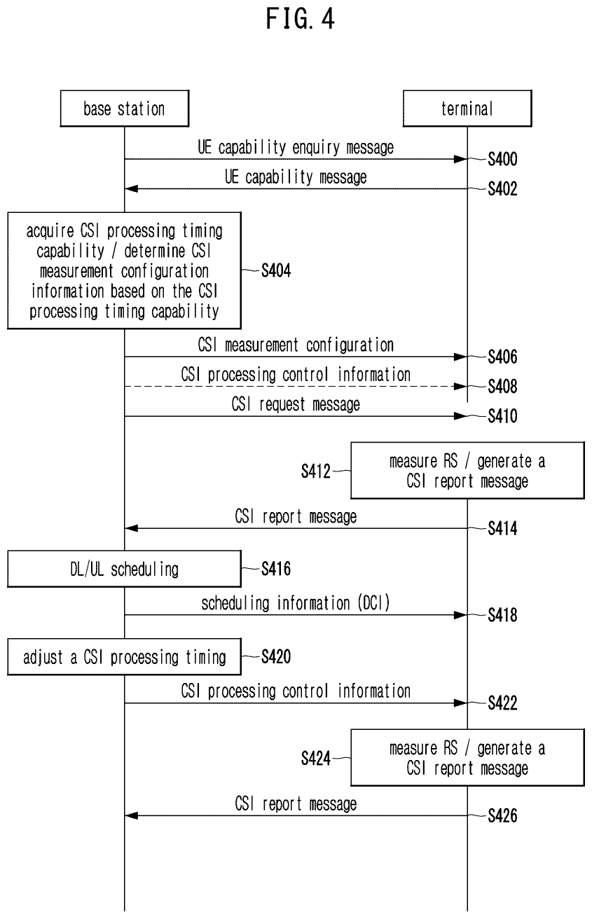

FIG. 4 is a sequence chart illustrating a scheduling procedure in which a base station acquires a terminal's CSI processing capability and performs scheduling based on the acquired CSI processing capability, in a wireless communication system.

The operations in FIG. 4 may correspond to a procedure between a base station and a terminal. The base station may include all or part of the components of the communication node described in FIG. 2. Additionally, the base station may include further components in addition to the components described in FIG. 2. For example, the base station may include an interface for communication with a higher-layer core network, an interface for communication with other base stations, and/or the like. The base station may further include an interface for communication with one or more transmission and reception points (TRPs) if the base station includes the TRP(s).

Similarly, the terminal may include all or part of the components of the communication node described in FIG. 2. Additionally, the terminal may include further components in addition to the components described in FIG. 2. For example, the terminal may include input devices for interfacing with users, one or more of various sensors, vibration motors, or camera devices. Examples of sensors may include one or more of a gyro sensor, a geomagnetic sensor, and an altitude sensor.

Referring to FIG. 4, in step S400, the base station may transmit a UE capability enquiry message to the terminal. The UE capability enquiry message may include a CSI processing timing enquiry IE. For convenience of description, the term ‘CSI processing timing enquiry IE’ may be used interchangeably with ‘CSI processing timing enquiry’ in the following description. The CSI processing timing enquiry may be one of IEs requesting UE radio access capabilities.

The terminal may receive the UE capability enquiry message from the base station. The terminal may identify whether the CSI processing timing enquiry is included in the received UE capability enquiry message.

In step S402, the terminal may generate a UE capability message in response to receiving the UE capability enquiry message. If the UE capability enquiry message received from the base station includes a CSI processing timing enquiry, the terminal may generate the UE capability message including CSI processing capability information that is to be used to determine a CSI processing timing. As another example, the UE capability enquiry message may request the terminal's comprehensive capabilities. In other words, there may not be a separate request for CSI processing timing. Even if there is no separate request for CSI processing timing, the terminal may generate the UE capability message including CSI processing capability information that is to be used to determine the CSI processing timing. In this case, the CSI processing capability may be directly indicated or configured as information from which the base station can indirectly infer the CSI processing capability, which is included in the UE capability message. In other words, the UE capability message may include CSI processing capability information that is to be used to determine the CSI processing timing.

In the present disclosure, it is assumed that the UE capability message includes CSI processing capability information that is to be used to determine the CSI processing timing. The CSI processing capability information of the terminal may represent a TTI interval and/or timing information required to perform CSI reporting based on the received RS(s), as described with reference to FIGS. 3A and 3B. When the CSI processing capability information indicates a TTI interval, different TTI intervals may be applied based on numerologies.

In step S402, the terminal may transmit the UE capability message including the CSI processing capability information that is to be used to determine the CSI processing timing to the base station. In step S402, the base station may receive the UE capability message transmitted by the terminal.

In step S404, the base station may acquire the CSI processing capability information from the UE capability message received from the terminal. The CSI processing capability information may be included in one of the UE radio access capability IEs within the UE capability message.

The base station may determine the CSI measurement configuration information based on the CSI processing capability information.

As described above, the CSI measurement configuration information may include one or more of the following: information indicating type(s) of RS(s) to be measured by the terminal for CSI reporting, information indicating an RS transmission pattern, information indicating an RS transmission periodicity, information indicating a location of RS resources in the time and/or spatial domain, or CSI report configuration information. The type(s) of RS(s) may indicate one of the RSs such as SSB or CSI-RS, as described earlier. The information indicating the RS transmission pattern may specify whether the RS(s) are continuous in OFDM symbols and/or subcarriers. The information indicating the RS transmission periodicity may specify a periodicity at which the RS is repeatedly transmitted. The information indicating the location of the RS resources may specify which OFDM symbol(s) the RS is located, a position of subcarrier(s) where the RS is transmitted, and/or an antenna port through which the RS is transmitted. Additionally, the CSI report configuration information may include information on a CSI reporting periodicity in the time domain, such as a position or periodicity of a slot or a TTI in which CSI reporting is performed, or the like. The CSI report configuration information may be configured with two or more values.

In step S406, the base station may transmit an RRC configuration message or RRC reconfiguration message including the CSI measurement configuration information determined in step S404 to the terminal. Consequently, in step S406, the terminal may receive the RRC configuration message or RRC reconfiguration message including the CSI measurement configuration information from the base station. As described above, when the CSI report configuration information includes two or more values, a MAC control element (MAC CE) may indicate which value included in the CSI report configuration the terminal needs to use. The terminal may obtain information required for CSI measurement based on the CSI measurement configuration information included in the RRC configuration message or RRC reconfiguration message.

Additionally, the CSI measurement configuration information may include one or more of the following: information indicating type(s) of RS(s) to be measured by the terminal, information on the RS transmission pattern, information on the RS transmission periodicity, or information on the location of RS resources in the time or frequency domain. The CSI measurement configuration information may also include CSI report configuration information. The CSI report configuration information may include one or more of a position of a slot where CSI reporting needs to be performed, a periodicity of the slot where CSI reporting needs to be performed, a periodicity of a TTI where CSI reporting needs to be performed, or a CSI reporting periodicity in the time domain.

Additionally or optionally, in step S408, the base station may generate CSI processing control information and transmit it to the terminal. The CSI processing control information may be transmitted using one of an RRC reconfiguration message, MAC CE, or Downlink Control Information (DCI). The CSI processing control information may include information on a CSI processing timing or information for determining the CSI processing timing. Additionally, the CSI processing control information may include one or more of a CSI reporting periodicity or a periodicity of valid RS. The CSI processing control information may be transmitted to the terminal through an RRC reconfiguration message, MAC CE, or DCI. If the CSI processing control information is transmitted through DCI, the CSI processing control information may be dynamically configured to the terminal. If the CSI processing control information is mandatorily transmitted, the CSI report configuration information may be included within the CSI processing control information.

A reason the base station transmits the CSI processing control information as in step S408 may include the following. If the terminal frequently performs CSI processing, the terminal's energy consumption may increase significantly. Therefore, the base station may reduce the terminal's energy consumption by dynamically configuring the CSI processing timing. For example, the base station may determine the CSI processing timing based on a reliability of the channel between the terminal and the base station, the terminal's network connection state (e.g. idle, connected, or inactive state), the terminal's energy-saving mode, and/or the type of terminal. As another example, the base station may determine the CSI processing timing based on a service quality required by a service provided to the terminal, such as a sensitivity to a latency required by the service or a required error rate of transmitted (or received) data. As yet another example, the base station may determine the CSI processing timing based on a combination of a channel reliability, the terminal's network connection state (e.g. idle, connected, or inactive state), the terminal's energy-saving mode, the type of the terminal, and the service quality required by the service, such as the sensitivity to latency and the required error rate of the transmitted (or received) data.

In step S406, the terminal that has received the CSI measurement configuration information may obtain information required for CSI measurement. In other words, the terminal may obtain one or more of the following: information indicating type(s) of RS to be measured by the terminal for CSI reporting, information indicating the RS transmission pattern, information indicating the RS transmission periodicity, information on the location of RS resources in the time and/or spatial domain, or CSI report configuration information. Furthermore, if the terminal has received the CSI processing control information in step S408, the terminal may obtain the CSI processing timing, CSI reporting periodicity, and/or valid RS periodicity information based on the CSI processing control information.

In step S410, the base station may transmit a CSI request message to the terminal. The CSI request message may be transmitted to the terminal through, for example, an RRC configuration message, RRC reconfiguration message, MAC CE, or DCI. Accordingly, the terminal may receive the CSI request message from the base station.

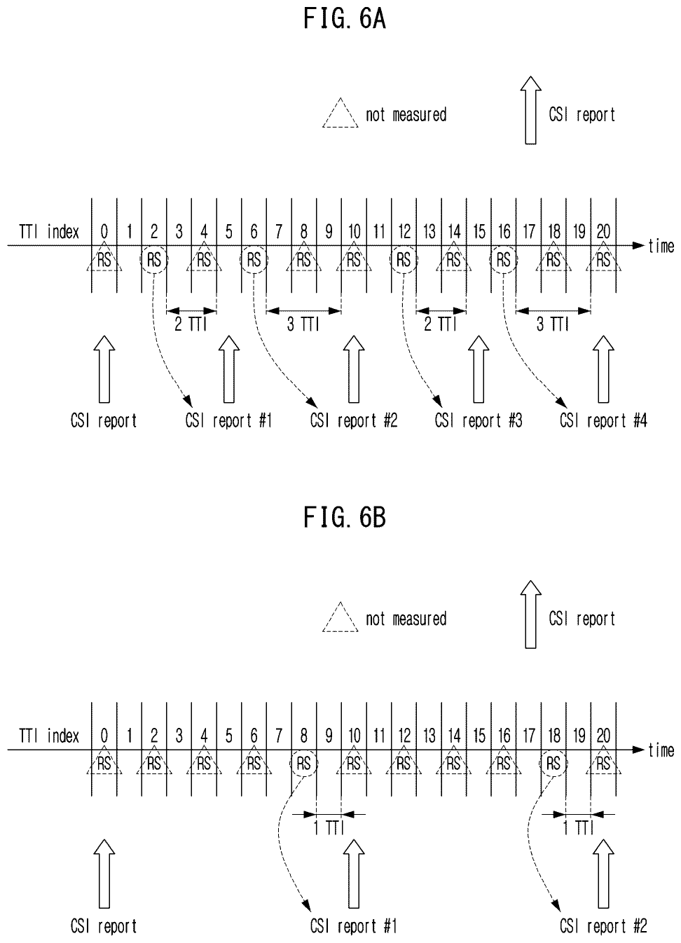

It should be noted that, for simplification, the operation of the base station transmitting the RS to the terminal is not illustrated in FIG. 4. The operation of the base station transmitting the RS to the terminal may be understood by referring to the examples described in FIG. 3A and FIG. 3B, or those described later in FIG. 6A and FIG. 6A.

In step S412, the terminal may receive the RS from the base station and measure the received RS in response to the CSI request message received in step S410. During the RS reception and measurement, the terminal may receive and measure valid RSs based on the CSI measurement configuration information or a combination of the CSI measurement configuration information and the CSI processing control information. The terminal may then generate a CSI report message based on the measured RS. The CSI report message may include one or more of CQI, MIMO PMI, RI, or LI, as described above.

In step S414, the terminal may transmit the CSI report message to the base station. In this case, the CSI report message may be transmitted through a physical uplink channel, such as Physical Uplink Control Channel (PUCCH) or Physical Uplink Shared Channel (PUSCH). When the CSI report message is included in a PUCCH or PUSCH, the CSI report message may be provided to the base station in form of Uplink Control Information (UCI). The terminal may transmit the UCI including the CSI report message to the base station through the PUCCH or PUSCH. Accordingly, in step S414, the base station may receive the CSI report message from the terminal.

When determining a transmission time in step S414, the terminal may determine the transmission time based on the CSI report configuration information included in the CSI measurement configuration information received in step S406. As another example, when determining a transmission time in step S414, the terminal may determine the transmission time based on at least one of the CSI report configuration information included in the CSI measurement configuration information received in step S406, the CSI processing timing information, the information for determining the CSI processing timing, or the CSI reporting periodicity received in step S408. In this case, a transmission position for CSI reporting may be determined as a TTI index, slot index, or symbol index. Accordingly, in step S414, the base station may receive the CSI report message from the terminal.

In step S416, the base station may perform downlink (DL) or uplink (UL) scheduling based on the CSI report message received from the terminal. In other words, the base station may allocate DL resources for transmitting data to the terminal or allocate UL resources for receiving data from the terminal through scheduling. Furthermore, the base station may determine a modulation and coding scheme (MCS) level for data to be transmitted to the terminal. Additionally, the base station may determine various pieces of information included in DCI.

In step S418, the base station may transmit scheduling information (i.e. DCI) to the terminal. The DCI including the scheduling information may be transmitted through a Physical Downlink Control Channel (PDCCH). Therefore, in step S418, the terminal may receive the DCI through the PDCCH. The DCI may include resource allocation information for receiving data through downlink or transmitting data through uplink. The terminal nay receive downlink data from the base station or transmit uplink data to the base station based on the DCI included in the PDCCH. Although not illustrated in FIG. 4, if downlink data is transmitted, the base station may transmit the data to the terminal through a PDSCH following the PDCCH. If the DCI transmitted through the PDCCH schedules the PDSCH, the terminal may receive the PDSCH following the PDCCH.

In step S420, the base station may adjust the CSI processing timing. The adjustment of the CSI processing timing may be determined based on the information described in step S408. For example, the base station may determine the CSI processing timing based on the service quality required by the service provided to the terminal, such as the sensitivity to latency or the required error rate of the transmitted (or received) data. Alternatively, the CSI processing timing may be determined based on the reliability of the channel between the terminal and the base station, the terminal's network connection state (e.g. idle, connected, or inactive state), the terminal's energy-saving mode, or the type of terminal.

In step S422, the base station may transmit the CSI processing control information to the terminal. Accordingly, the terminal may receive the CSI processing control information from the base station in step S422. As described above, the CSI processing control information may include one or more of the terminal's CSI processing timing information, information for determining the CSI processing timing, the CSI reporting periodicity, or the valid RS periodicity. Therefore, the terminal may configure one or more of the CSI processing timing information, CSI reporting periodicity, or valid RS periodicity based on the CSI processing control information received in step S422.

For example, when the terminal's CSI processing timing information is configured, although the terminal reported a CSI processing timing of 1 TTI in the CSI processing capability information within the UE capability message, if the CSI processing control information received from the base station specifies a CSI processing timing of 2 TTIs or 4 TTIs, the terminal may set the CSI processing timing to 2 TTIs or 4 TTIs.

For the CSI reporting periodicity, the terminal may receive the CSI report configuration information in the RRC configuration message or RRC reconfiguration message that includes two or more values or a single specific value. For example, if the CSI report configuration information specifies a CSI reporting periodicity of 5 TTIs, the terminal may generate and report CSI report messages to the base station at an interval of 5 TTIs. If the received CSI processing control information specifies a CSI reporting periodicity of 10 TTIs, the terminal may adjust a reporting periodicity of CSI report messages from 5 TTIs to 10 TTIs.

For the valid RS periodicity, if the base station transmits RS at an interval of 2 TTIs, a specific valid RS transmission periodicity may be separately configured for the terminal.

As described above, the terminal may obtain one or more of the CSI processing timing, CSI reporting periodicity, or valid RS periodicity based on the CSI processing control information received from the base station in step S422. The terminal may determine the reception and measurement timing of the RS, configure the CSI processing timing, and/or decide the CSI reporting periodicity based on the CSI processing control information.

In step S424, the terminal may measure the RS(s) received from the base station based on the CSI measurement configuration information received in step S406 and the CSI processing control information received in step S422. Since the terminal has received the CSI processing control information, the terminal may use only information from the CSI measurement configuration information received in step S406 that has not been modified by the CSI processing control information. The terminal may generate a CSI measurement report message based on the measured RS(s). The CSI measurement report message may include one or more of CQI, MIMO PMI, RI, or LI, as described in step S414. The CSI measurement report message may also be transmitted to the base station through a PUCCH or PUSCH. In this case, the CSI measurement report message may be configured in form of UCI.

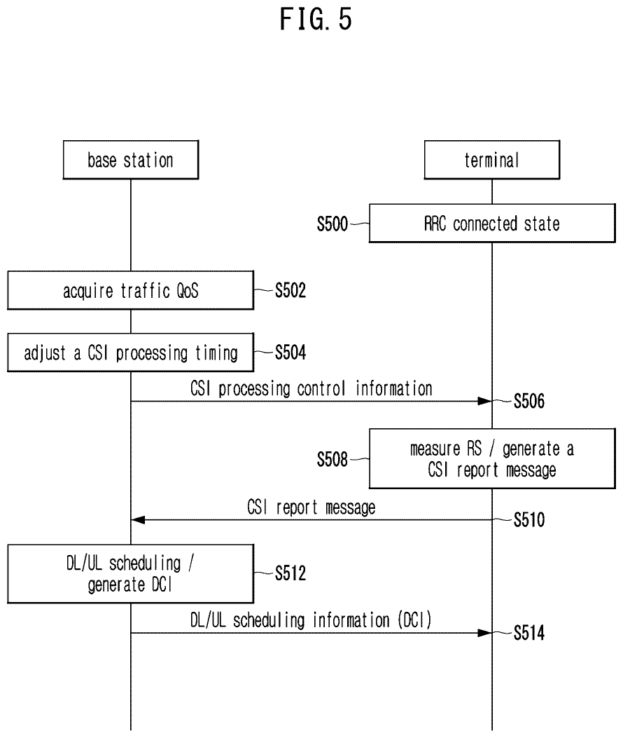

FIG. 5 is a sequence chart illustrating a procedure for adjusting and scheduling a CSI processing timing based on a service quality of traffic of a terminal in an RRC-connected state in a wireless communication system.

The operations in FIG. 5 may represent a procedure between the base station and the terminal. The base station may include all or part of the components of the communication node described in FIG. 2. Additionally, the base station may include further components in addition to the components described in FIG. 2. For example, the base station may include an interface for communication with a higher-layer core network, an interface for communication with other base stations, and/or the like. The base station may further include an interface for communication with one or more TRPs if the base station includes the TRP(s).

The terminal may also include all or part of the components of the communication node described in FIG. 2. Additionally, the terminal may include further components in addition to the components shown in FIG. 2. For example, the terminal may include input devices for interfacing with users and may further include one or more of various sensors, vibration motors, or camera devices. Examples of sensors may include, but are not limited to, one or more of a gyro sensor, a geomagnetic sensor, or an altitude sensor.

Referring to FIG. 5, in step S500, the terminal may be in the RRC connected state. FIG. 5 assumes that the terminal has transitioned from one of the RRC idle state or RRC inactive state to the RRC connected state. Additionally, prior to step S500 shown in FIG. 5, the terminal may have already transmitted a UE capability message to the base station. The UE capability message may include CSI processing capability information that is to be used to determine the terminal's CSI processing timing, as described above. Therefore, the base station may have received and acquired the terminal's CSI processing capability information from the terminal prior to step S500 in FIG. 5.

In step S502, the base station may acquire quality of service (QOS) information for traffic to be provided to the terminal. The QoS information for the traffic to be provided to the terminal may include a sensitivity to latency required by the service or the required error rate of the transmitted (or received) data, as described earlier. In addition to the examples provided above, the QoS information may also include additional requirements. In step S502, the QoS information for the traffic to be provided to the terminal may be received from a specific node in the core network of the mobile communication system.

In step S504, the base station may adjust a CSI processing timing based on the QoS information for the traffic to be provided to the terminal. If the base station has not received UE capability information from the terminal prior to step S500, the base station may adjust the CSI processing timing based solely on the QoS information for the traffic to be provided to the terminal in step S504. Conversely, if the base station has received UE capability information from the terminal prior to step S500, the base station may adjust the CSI processing timing by considering both the QoS information for the traffic to be provided to the terminal and the UE capability information acquired from the terminal prior to step S500.

In step S506, the base station may transmit CSI processing control information to the terminal. In this case, the CSI processing control information may be transmitted to the terminal using one of an RRC reconfiguration message, MAC CE, or DCI. Accordingly, in step S506, the terminal may receive the CSI processing control information from the base station.

In step S508, the terminal may measure RS(s) based on the received CSI processing control information and generate a CSI report message to be reported to the base station based on the measured RS(s). The CSI report message may include one or more of CQI, MIMO PMI, RI, or LI. It should be noted that in FIG. 5, the operation of the base station transmitting the RS(s) is not illustrated to avoid complexity in the drawing.

Unlike the example in FIG. 4, FIG. 5 illustrates a case where the CSI report message is generated and transmitted without receiving a CSI request message. In other words, even without receiving a CSI request message, the terminal may generate the CSI report message based on the CSI processing control information and transmit the CSI report message to the base station. Accordingly, in step S510, the base station may receive the CSI report message from the terminal.

In step S512, the base station may perform downlink and/or uplink scheduling based on the CSI report message received from the terminal. Based on the scheduling, the base station may generate DCI to be transmitted to the terminal.

In step S514, the base station may transmit scheduling information to the terminal. As described earlier in FIG. 4, the scheduling information may be included in the DCI, which is transmitted through a PDCCH. Additionally, the DCI may include resource allocation information for receiving data through downlink or transmitting data through uplink. The terminal may receive downlink data from the base station or transmit uplink data to the base station based on the DCI included in the PDCCH. Although not illustrated in FIG. 5, if downlink data is transmitted, the base station may transmit the data to the terminal through a PDSCH following the PDCCH. Therefore, the terminal may receive the DCI through the PDCCH in step S514.

FIG. 6A is a timing diagram illustrating an exemplary embodiment of a method for wireless channel measurement and CSI reporting according to the present disclosure.

Referring to FIG. 6A, the horizontal axis may represent time in units of a TTI. The TTI may be a scheduling unit for a base station to perform data transmission. From a downlink perspective, hierarchically, a MAC layer of the base station may deliver a scheduled TB to a PHY layer of the base station at each TTI interval. The PHY layer of the base station may wirelessly transmit the TB received from the MAC layer to a terminal at each TTI interval. In the LTE system, the length of the TTI may be set to 1 ms which corresponds to a single subframe. Additionally, in the NR system, a time duration of each slot may vary depending on a numerology. Therefore, in the NR system, the TTI may correspond to a scheduled slot unit. For simplicity, description below assumes that a single TTI corresponds to a single scheduled slot.

In FIG. 6A, as in the example of FIG. 3A, TTI indexes are illustrated from a TTI index #0 to TTI index #20, covering a total of 21 TTI indexes. For convenience of description, the description of FIG. 6A refers to SSB or CSI-RS collectively as RS.

As shown in the example of FIG. 6A, the base station may set the RS transmission periodicity to 2 TTIs and the CSI reporting periodicity to 5 TTIs. Accordingly, in the example of FIG. 6A, the RS may be transmitted at TTI indexes #0, #2, #4, #6, #8, #10, #12, #14, #16, #18, and #20. Additionally, in the example of FIG. 6A CSI reporting may be performed at TTI indexes #0, #5, #10, #15, and #20.

The base station may acquire CSI processing capability information from the terminal as described in FIG. 4 and/or FIG. 5. In other words, the base station may transmit a UE capability enquiry message to the terminal and receive a UE capability message from the terminal in response to the UE capability enquiry message. The UE capability message may include a CSI processing timing capability of the terminal. Accordingly, the base station may acquire the terminal's CSI processing timing capability. Based on the acquired CSI processing timing capability, the base station may transmit CSI measurement configuration information to the terminal. The CSI measurement configuration information may include one or more of the following: information indicating type(s) of RS(s) to be measured by the terminal for CSI reporting, information indicating an RS transmission pattern, information indicating an RS transmission periodicity, information on a location of RS resource(s) in the time and/or spatial domain, or CSI report configuration information. Additionally, the CSI measurement configuration information may be transmitted to the terminal through an RRC configuration message or RRC reconfiguration message.

Thus, the terminal may acquire the CSI measurement configuration information. As described above, the CSI measurement configuration may be transmitted from the base station to the terminal using either an RRC configuration message or RRC reconfiguration message. The terminal may determine which RS to measure based on the CSI measurement configuration information received from the base station and may identify TTIs in which the RS is to be transmitted. Furthermore, the terminal may acquire CSI reporting periodicity and CSI reporting location information based on the CSI measurement configuration information. Therefore, the terminal may identify the nearest RS based on the CSI reporting periodicity and CSI reporting location information.

Referring to FIG. 6A, the terminal may identify the RS nearest to a CSI report #1 based on the CSI measurement configuration. For example, the terminal may determine a TTI index of the RS for CSI reporting based on the RS type, RS transmission pattern, RS transmission periodicity, and CSI report configuration included in the CSI measurement configuration. Specifically, the terminal may identify the RS to be measured based on the RS type included in the CSI measurement configuration. The terminal may determine when the RS is transmitted based on the RS transmission pattern and RS transmission periodicity included in the CSI measurement configuration. Additionally, the terminal may identify which RS, or more specifically, the TTI index of the RS to be measured for CSI reporting based on the CSI report configuration included in the CSI measurement configuration and the terminal's CSI processing capability.

Based on the above-described determination, the terminal may determine the RS to be measured for the CSI report #1 after a reporting time of CSI #0, among the RSs transmitted at the TTI indexes #2 and #4.

In the example of FIG. 6A, since the terminal's CSI processing capability is 2 TTIs, the terminal may confirm that the RS transmitted by the base station at the TTI index #2 is the RS to be used for CSI reporting. Therefore, the terminal may receive and measure the RS transmitted by the base station at the TTI index #2 and generate CSI for CSI reporting. The CSI may include one or more of CQI, MIMO PMI, RI, or LI, as described earlier.

As described above, to transmit the CSI report #1, the terminal receives and measures the RS transmitted by the base station at the TTI index #2 and generates CSI. Accordingly, the terminal may not measure the RS transmitted by the base station at the TTI index #4.

Similarly, the terminal may determine that a CSI report #2 needs to be transmitted at the next CSI reporting time, TTI index #10. The terminal may also identify the TTI indexes at which RSs are to be transmitted after the CSI report #1. In other words, the terminal may identify that the base station is to transmit the RSs at the TTI indexes #6, #8, and #10. Therefore, based on the terminal's CSI processing capability, the terminal may identify which TTI index's RS needs to be received for CSI reporting at a reporting time of the CSI report #2. Specifically, the terminal may determine that for CSI reporting at the reporting time of the CSI report #2, the RS transmitted by the base station at the TTI index #6 needs to be received and measured to generate the CSI report message. Accordingly, the terminal may receive and measure the RS transmitted by the base station at the TTI index #6 and generate the CSI report message. The terminal may not measure the RS transmitted by the base station at the TTI indexes #8 and #10.

For a CSI report #3, the same method as for the CSI report #1 may be applied. Similarly, for a CSI report #4, the same method as for the CSI report #2 may be applied. In other words, for the CSI report #3, the terminal may receive and measure the RS transmitted by the base station at the TTI index #12 to generate the CSI report message, and the terminal may not measure the RS transmitted by the base station at the TTI index #14. For the CSI report #4, the terminal may receive and measure the RS transmitted by the base station at the TTI index #16 to generate the CSI report message, and the terminal may not measure the RS transmitted by the base station at the TTI indexes #18 and #20.

As described above, the terminal may not measure all RSs transmitted by the base station but determine which RS to measure based on the terminal's CSI processing capability. Therefore, the terminal may not measure RS that is not used for CSI reporting. The terminal according to the present disclosure has the advantage of reducing power consumption because the terminal does not measure RS that is not used for CSI reporting.

In the above description, the case where CSI measurement configuration information is provided to the terminal based on CSI processing capability information obtained by the base station from the terminal has been described. However, the same may be applied when both CSI measurement configuration information and CSI processing control information are provided together. If the terminal's CSI processing capability is 1 TTI, the base station may configure the CSI processing timing to 2 TTIs using the CSI processing control information. The base station may provide the terminal with the CSI processing control information, which includes the CSI processing timing set to 2 TTIs or information for determining the CSI processing timing. In this case, the terminal may operate in the same manner as described in FIG. 6A based on the CSI processing timing information included in the CSI processing control information.

FIG. 6B is a timing diagram illustrating another exemplary embodiment of a method for wireless channel measurement and CSI reporting according to the present disclosure.

Before describing FIG. 6B, the base station may have provided the terminal with CSI measurement configuration information and CSI processing control information based on CSI processing timing information obtained from the terminal. FIG. 6B assumes a scenario where the CSI processing control information provided to the terminal sets the CSI processing timing to 1 TTI. Additionally, in FIG. 6B, the CSI measurement configuration assumes that the RS transmission periodicity is set to 2 TTIs and the CSI reporting periodicity is set to 10 TTIs.

Referring to FIG. 6B, the horizontal axis represents time in TTI units, and the TTI indexes shown in FIG. 6B may represent scheduling units for data transmission by the base station.

In FIG. 6B, the TTI indexes range from a TTI index #0 to TTI index #20, totaling 21 TTI indexes. For simplicity, SSB or CSI-RS is collectively referred to as RS in the description of FIG. 6B.

Since the RS transmission periodicity is set to 2 TTIs, the RSs may be transmitted at the TTI indexes #0, #2, #4, #6, #8, #10, #12, #14, #16, #18, and #20. Additionally, since the CSI reporting periodicity is set to 10 TTIs, CSI reporting may occur at the TTI indexes #0, #10, and #20.

Before describing FIG. 6B, the base station may obtain the CSI processing timing capability of the terminal, as described in FIG. 4 and/or FIG. 5. Specifically, the base station may transmit a UE capability enquiry message to the terminal and receive a UE capability message in response. The UE capability message may include the CSI processing timing capability. Based on the obtained CSI processing timing capability, the base station may configure CSI measurement configuration information. The base station may transmit the CSI measurement configuration information to the terminal through an RRC configuration message or RRC reconfiguration message. The CSI measurement configuration information may include one or more of the following: information indicating type(s) of RS(s) to be measured for CSI reporting, information indicating an RS transmission pattern, information indicating an RS transmission periodicity, information indicating a location of RS resource(s) in the time and/or spatial domain, or CSI report configuration information.

Furthermore, the base station may determine CSI processing control information based on a QoS for data traffic provided to the terminal and the terminal's CSI processing capability information. The base station may then provide the CSI processing control information to the terminal.

For example, even if the terminal's CSI processing capability information supports 1 TTI, the base station may provide CSI processing control information that sets the CSI processing timing capability to 2 TTIs based on the QoS of the data traffic provided to the terminal, as shown in FIG. 6A.

Alternatively, if the terminal's CSI processing capability information supports 1 TTI and the QoS of the data traffic provided to the terminal requires 1 TTI reporting, the base station may provide CSI processing control information that sets the CSI processing timing to 1 TTI.

As described above, the operation of RS measurement and CSI reporting in the terminal when the CSI measurement configuration and CSI processing control information are provided to the terminal will be described with reference to FIG. 6B.

Referring to FIG. 6B, the terminal may determine in advance an RS nearest to a CSI report #1 based on the CSI measurement configuration. For example, the terminal may identify the TTI indexes of RSs for CSI reporting based on the RS type, RS transmission pattern, RS transmission periodicity, and CSI report configuration included in the CSI measurement configuration. More specifically, the terminal may identify the type of RS to measure based on the RS type included in the CSI measurement configuration. The terminal may determine when the RS is transmitted based on the RS transmission pattern and RS transmission periodicity included in the CSI measurement configuration. Additionally, the terminal may identify which RS to measure for CSI reporting based on the CSI report configuration included in the CSI measurement configuration and the CSI processing timing included in the CSI processing control information received from the base station. In other words, the terminal may identify which TTI index corresponds to the RS to measure.

Based on the above-described determinations, the terminal may decide that the RS to measure for the CSI report #1 is the RS transmitted at the TTI index #8, among the RSs transmitted at the TTI indexes #2, #4, #6, #8, and #10 after a reporting time of CSI #0.

Therefore, the terminal may receive and measure the RS transmitted by the base station at the TTI index #8 and generate CSI for CSI reporting. The CSI may include one or more of CQI, MIMO PMI, RI, or LI, as described earlier.

As describe above, to transmit the CSI report #1, the terminal receives and measures the RS transmitted by the base station at the TTI index #8 and generates CSI. Thus, the terminal may not measure the RSs transmitted by the base station at the TTI indexes #2, #4, and #6.

In the same manner, the terminal may determine that the next CSI reporting time is at the TTI index #20 for a CSI report #2. Accordingly, the terminal may receive and measure the RS transmitted by the base station at the TTI index #18 and generate CSI for the CSI report #2. The terminal may not measure the RSs transmitted by the base station at the TTI indexes #12, #14, and #16.

As described above, the terminal may determine which RS to measure based on the terminal's CSI processing capability rather than measuring all RSs transmitted by the base station. Therefore, the terminal may not measure RSs that are not used for CSI reporting. This provides the advantage of reducing power consumption in the terminal.

Furthermore, as shown in FIG. 6B, when CSI reporting is performed based on the CSI processing timing, the terminal may transmit more reliable wireless channel information to the base station. Consequently, the base station can allocate more optimal wireless resources to the terminal when scheduling downlink and/or uplink transmissions, providing an additional advantage.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a user equipment (UE), comprising:
receiving a UE capability enquiry message from a base station;
in response to the UE capability enquiry message, transmitting, to the base station, a UE capability message including CSI processing capability information capable of determining a CSI processing timing of the UE;
receiving channel state information (CSI) measurement configuration information from the base station;
measuring a reference signal (RS) received from the base station based on the CSI measurement configuration information and the CSI processing capability information; and
transmitting, to the base station, a first CSI report message based on the measurement of the RS.

2. The method according to claim 1, wherein the CSI measurement configuration information includes at least one of information indicating type(s) of RS(s) to be measured by the UE, information on an RS transmission pattern, information on an RS transmission periodicity, information on a location of RS resource(s) in time and frequency domain, or CSI report configuration information, and the CSI report configuration information includes at least one of a position of a slot in which CSI reporting needs to be performed, a periodicity of the slot in which CSI reporting needs to be performed, a periodicity of a transmission time interval (TTI) in which CSI reporting needs to be performed, or a CSI reporting periodicity in time domain.

3. The method according to claim 1, wherein when measuring RSs received from the base station, the UE measures only RS(s) required for CSI reporting among RSs received from the base station based on the CSI measurement configuration information and the CSI processing capability information.

4. The method according to claim 1, further comprising:
receiving, from the base station, CSI processing control information including at least one information element among information on a CSI processing timing, information for determining a CSI processing timing, or CSI reporting periodicity;
measuring RS(s) received from the base station based on the CSI processing control information, the CSI measurement configuration information, and the CSI processing capability information; and
transmitting a second CSI reporting message based on the measurement of the RS to the base station, based on the CSI measurement configuration information or the CSI processing control information.

5. The method according to claim 4, wherein the CSI processing control information is determined based on one or more of a quality of service (QOS) of data traffic provided to the UE, a reliability of a channel between the UE and the base station, a network connection state of the UE, an energy saving mode of the UE, or a type of the UE, and the network connection state of the UE indicates one of an idle state, a connected state, or an inactive state.

6. The method according to claim 4, wherein the CSI processing control information further includes information indicating a periodicity of valid RSs among RSs transmitted by the base station.

7. The method according to claim 6, wherein the terminal measures only the valid RSs indicated by the CSI processing control information among RSs received from the base station.

8. A method of a base station, comprising:
transmitting a user equipment (UE) capability enquiry message to a UE;
receiving, from the UE, a UE capability message including CSI processing capability information capable of determining a CSI processing timing of the UE;
generating channel state information (CSI) measurement configuration information based on the CSI processing capability information of the UE;
transmitting the CSI measurement configuration information to the UE; and
receiving a first CSI report message from the UE,
wherein the first CSI report message includes information obtained by measuring a reference signal (RS) transmitted by the base station to the UE based on the CSI measurement configuration information and the CSI processing capability information.

9. The method according to claim 8, wherein the CSI measurement configuration information includes at least one of information indicating type(s) of RS(s) to be measured by the UE, information on an RS transmission pattern, information on an RS transmission periodicity, information on a location of RS resource(s) in time and frequency domain, or CSI report configuration information, and the CSI report configuration information includes at least one of a position of a slot in which CSI reporting needs to be performed, a periodicity of the slot in which CSI reporting needs to be performed, a periodicity of a transmission time interval (TTI) in which CSI reporting needs to be performed, or a CSI reporting periodicity in time domain.

10. The method according to claim 8, further comprising:
generating CSI processing control information based on the CSI processing capability information of the UE and second information;
transmitting the CSI processing control information to the UE; and
receiving a second CSI report message from the UE based on the CSI measurement configuration information and the CSI processing control information,
wherein the CSI processing control information includes one or more information elements among information on a CSI processing timing, information for determining a CSI processing timing, and a CSI reporting periodicity.

11. The method according to claim 10, wherein the second information includes one or more of a quality of service (QOS) of data traffic provided to the UE, a reliability of a channel between the UE and the base station, a network connection state of the UE, an energy saving mode of the UE, or a type of the UE, and the network connection state of the UE indicates one of an idle state, a connected state, or an inactive state.

12. The method according to claim 10, wherein the CSI processing control information further includes information indicating a periodicity of valid RSs among RSs transmitted by the base station.

13. The method according to claim 10, further comprising:
allocating resources to communicate with the UE based on the second CSI report message; and
transmitting allocation information on the resources to the UE through downlink control information (DCI).

14. A user equipment (UE) comprising at least one processor, wherein the at least one processor causes the UE to perform:
receiving a UE capability enquiry message from a base station;
in response to the UE capability enquiry message, transmitting, to the base station, a UE capability message including CSI processing capability information capable of determining a CSI processing timing of the UE;
receiving channel state information (CSI) measurement configuration information from the base station;
measuring a reference signal (RS) received from the base station based on the CSI measurement configuration information and the CSI processing capability information; and
transmitting, to the base station, a first CSI report message based on the measurement of the RS.

15. The UE according to claim 14, wherein the CSI measurement configuration information includes at least one of information indicating type(s) of RS(s) to be measured by the UE, information on an RS transmission pattern, information on an RS transmission periodicity, information on a location of RS resource(s) in time and frequency domain, or CSI report configuration information, and the CSI report configuration information includes at least one of a position of a slot in which CSI reporting needs to be performed, a periodicity of the slot in which CSI reporting needs to be performed, a periodicity of a transmission time interval (TTI) in which CSI reporting needs to be performed, or a CSI reporting periodicity in time domain.

16. The UE according to claim 14, wherein the at least one processor causes the UE to perform: when measuring RSs received from the base station, measuring only RS(s) required for CSI reporting among RSs received from the base station based on the CSI measurement configuration information and the CSI processing capability information.

17. The UE according to claim 14, wherein the at least one processor further causes the UE to perform:
receiving, from the base station, CSI processing control information including at least one information element among information on a CSI processing timing, information for determining a CSI processing timing, or CSI reporting periodicity;
measuring RS(s) received from the base station based on the CSI processing control information, the CSI measurement configuration information, and the CSI processing capability information; and
transmitting a second CSI reporting message based on the measurement of the RS to the base station, based on the CSI measurement configuration information or the CSI processing control information.

18. The UE according to claim 17, wherein the CSI processing control information is determined based on one or more of a quality of service (QOS) of data traffic provided to the UE, a reliability of a channel between the UE and the base station, a network connection state of the UE, an energy saving mode of the UE, or a type of the UE, and the network connection state of the UE indicates one of an idle state, a connected state, or an inactive state.

19. The UE according to claim 17, wherein the CSI processing control information further includes information indicating a periodicity of valid RSs among RSs transmitted by the base station.

20. The UE according to claim 19, wherein the at least one processor further causes the UE to perform: measuring only the valid RSs indicated by the CSI processing control information among RSs received from the base station.
